(19) United States
(12) Patent Application Publication
(10) Pub. No.: US 2022/0310091 A1
(43) Pub. Date: Sep. 29, 2022

(54) METHOD AND APPARATUS FOR INTERACTING WITH INTELLIGENT RESPONSE SYSTEM

(71) Applicant: Samsung Electronics Co., Ltd., Suwon-si, Gyeonggi-do (KR)

(72) Inventors: Yinhe ZHENG, Beijing (CN); Song LIU, Beijing (CN); Qing WANG, Beijing (CN); Yimeng ZHUANG, Beijing (CN); Tiancong PANG, Beijing (CN)

(21) Appl. No.: 17/616,836

(22) PCT Filed: Jun. 8, 2020
(86) PCT No.: PCT/KR2020/007401

§ 371 Date: Dec. 6, 2021

(30) Foreign Application Priority Data
Jun. 6, 2019 (CN) 201910491681.9

(51) Int. Cl. G10L 15/22; G10L 15/00; G06F 3/0482

(52) U.S. Cl. CPC G10L 15/22; G10L 15/005; G06F 3/0482; G10L 2015/223; G10L 2015/225

(57) ABSTRACT

A method and apparatus for interacting with an intelligent response system is provided. The method comprises: receiving a user input; identifying user intent based on content of the user input; and automatically interacting with an intelligent response system involved in the user intent to achieve the user intent. According to the method and apparatus, interacting with the corresponding intelligent response system is automatically performed only based on the user input reflecting the user intent to achieve the user intent without directly interacting with the intelligent response system by the user.

### TECHNICAL FIELD

The present disclosure generally relates to a field of electronic technology, and more particularly, to a method and apparatus for interacting with an intelligent response system.

### BACKGROUND ART

With the development of electronic technology, in order to save labor costs and facilitate the provision of services to customers, merchants usually provide automatic response systems, and a user can implement some self-service services by using these automatic response systems. For example, a network operator provides an automatic response system related to its own business, through which the user can achieve self-checking of telephone charge or handling business, etc.; some travel agencies also provide similar automatic response systems for the user to query and book a travel route. The user can interact with the automatic response system in different ways. For example, the corresponding number can be input according to a prompt of the automatic response system to select the corresponding option, or voices can be directly used for dialogue interaction with the automatic response system, for example, autonomous ordering systems provided by some restaurants can accept the user's voice input and can communicate with the user in a voice conversation.

### DISCLOSURE OF INVENTION

### Solution to Problem

A method and apparatus for interacting with an intelligent response system is provided. The method comprises: receiving a user input; identifying user intent based on content of the user input; and automatically interacting with an intelligent response system involved in the user intent to achieve the user intent.

### BRIEF DESCRIPTION OF DRAWINGS

The above and other purpose and feature of the exemplary embodiments of the present disclosure will become more clear, through the following descriptions combining the accompanying drawings which exemplarily illustrate the embodiments, in which:

FIG. 1 illustrates a flow chart of a method for interacting with an intelligent response system according to an exemplary embodiment of the present disclosure.

FIG. 2 illustrates an example of a personalized information database according to an exemplary embodiment of the present disclosure.

FIG. 3 illustrates an example of generating a context feature according to an exemplary embodiment of the present disclosure.

FIG. 4 illustrates an example of identifying user intent according to an exemplary embodiment of the present disclosure.

FIG. 5 illustrates an example of interacting with a plurality of intelligent response systems according to an exemplary embodiment of the present disclosure.

FIG. 6 illustrates an example of requesting user to supplement information according to an exemplary embodiment of the present disclosure.

FIG. 7 illustrates a flowchart of a method for interacting with an intelligent response system according to user intent and functions of candidate items in an interactive menu provided by the intelligent response system, according to an exemplary embodiment of the present disclosure.

FIG. 8 illustrates an example of interacting with an intelligent response system according to user intent and functions of candidate items in an interactive menu provided by the intelligent response system, according to an exemplary embodiment of the present disclosure.

FIG. 9 illustrates an example of generating a combination of menu operation paths according to an exemplary embodiment of the present disclosure.

FIG. 10 illustrates an example of providing user privacy information to an intelligent response system according to an exemplary embodiment of the present disclosure.

FIG. 11 illustrates an example of obtaining an interaction result through a short message according to an exemplary embodiment of the present disclosure.

FIG. 12 illustrates an example of interacting with an intelligent response system according to an exemplary embodiment of the present disclosure.

FIG. 13 illustrates an example of continuing to achieve user intent by other interaction manners according to an exemplary embodiment of the present disclosure.

FIG. 14 illustrates another example of interacting with an intelligent response system according to an exemplary embodiment of the present disclosure.

FIG. 15 illustrates a block diagram of a structure of an apparatus for interacting with an intelligent response system according to an exemplary embodiment of the present disclosure.

FIG. 16 illustrates a block diagram of a structure of an interacting unit according to an exemplary embodiment of the present disclosure.

FIG. 17 illustrates a block diagram of a structure of a selecting unit according to an exemplary embodiment of the present disclosure.

FIG. 18 illustrates a structural block diagram of an apparatus for interacting with an intelligent response system according to an exemplary embodiment of the present disclosure.

### BEST MODE FOR CARRYING OUT THE INVENTION

Exemplary embodiments of the present disclosure are to provide a method and apparatus for interacting with an intelligent response system to solve the problem that the manner of interaction with the intelligent response system existing in the prior art is not intelligent and convenient enough, and wastes time and energy of the user.

According to an exemplary embodiment of the present disclosure, a method for interacting with an intelligent response system is provided, wherein the method includes: receiving a user input; identifying user intent based on content of the user input; automatically interacting with an intelligent response system involved in the user intent to achieve the user intent.

In one embodiment, the received user input may includes a user voice input.

In one embodiment, the automatic interacting with the intelligent response system comprises: simulating a user input according to the user intent, wherein the simulated user input includes a simulated user voice input or a simulated user touch input.

In one embodiment, the automatic interacting with the intelligent response system comprises: determining a plurality of intelligent response systems for achieving the user intent; and automatically interacting with the plurality of intelligent response systems.

In one embodiment, the method further includes: providing a user with an interaction result with the intelligent response system when the interaction process with the intelligent response system is completed.

In one embodiment, the automatic interacting with the intelligent response system involved in the user intent comprises: selecting a corresponding candidate item by simulating a user input, according to the user intent and functions of candidate items in an interactive menu provided by the intelligent response system.

In one embodiment, the automatic interacting with the intelligent response system involved in the user intent comprises: determining the intelligent response system for achieving the user intent; and selecting a corresponding candidate item by simulating a user input, according to the user intent and functions of candidate items in an interactive menu provided by the intelligent response system.

In one embodiment, the selecting of the corresponding candidate item by simulating the user input, according to the user intent and the functions of the candidate items in the interactive menu provided by the intelligent response system comprises: obtaining a menu tree of the intelligent response system, wherein the menu tree is used to indicate candidate items included in an interaction menu at each level of the intelligent response system and functions corresponding to the candidate items; obtaining a menu operation path for achieving the user intent for the menu tree; and sequentially performing menu operations in the menu operation path by simulating a user input, wherein when content fed back by the intelligent response system in response to one menu operation satisfies a trigger condition of a next menu operation of the one menu operation, the next menu operation is performed.

In one embodiment, the selecting of the corresponding candidate item by simulating the user input, according to the user intent and the functions of the candidate items in the interactive menu provided by the intelligent response system comprises: selecting a candidate item for achieving the user intent by simulating a user input, based on functions of candidate items in an interaction menu provided in real time by the intelligent response system.

In one embodiment, the automatic interacting with the intelligent response system involved in the user intent comprises: obtaining information for achieving the user intent; and automatically interacting with the intelligent response system involved in the user intent, based on the obtained information.

In one embodiment, the obtaining of the information for achieving the user intent comprises: extracting information for achieving the user intent from the content of the user input; and/or obtaining context information for achieving the user intent, wherein the context information includes at least one of current environment information, historical operation information of an electronic terminal, and stored user personalized information.

In one embodiment, the method further includes: prompting a user to supplement corresponding information and identifying the user intent based on the information supplemented by the user, when the user intent cannot be recognized; and/or prompting the user to supplement corresponding information and determining the involved intelligent response system based on the information supplemented by the user, when the involved intelligent response system cannot be determined based on the identified user intent; and/or prompting the user to supplement corresponding information and interacting with the involved intelligent response system based on the information supplemented by the user, when it is not possible to interact with the involved intelligent response system based on the identified user intent.

In one embodiment, the identifying of the user intent based on the content of the user input comprises: identifying the user intent based on the content of the user input and context information, wherein the context information comprises at least one of current environmental information, historical operation information of the electronic terminal, or stored user personalized information.

In one embodiment, the method further includes: when user privacy information needs to be provided to the intelligent response system, confirming to the user whether the user privacy information is provided to the intelligent response system, wherein when a confirmation input of the user is received, the user privacy information is provided to the intelligent response system during the interaction with the intelligent response system.

In one embodiment, the method further comprises: after the interaction process with the intelligent response system ends, when the user intent has not been achieved and the intelligent response system provides other interaction manners for achieving the user intent, automatically interacting in the other interaction manners.

In one embodiment, the method further comprises: after the interaction process with the intelligent response system ends, when the user intent has not been achieved and the intelligent response system provides other interaction manners for achieving the user intent, automatically interacting in the other interaction manners; and providing the user with a corresponding interaction result when the user intent has been achieved by interacting in the other interaction manners.

In one embodiment, the selecting of the corresponding candidate item by simulating the user input, according to the user intent and the functions of the candidate items in the interactive menu provided by the intelligent response system comprises: when the content fed back by the intelligent response system in response to the one menu operation does not satisfy the trigger condition of the next menu operation of the one menu operation, updating the menu operation path based on the content fed back and the user intent; and sequentially performing menu operations in the updated menu operation path by simulating a user input.

In one embodiment, the method further includes: when the content fed back by the intelligent response system in response to the one menu operation does not satisfy the trigger condition of the next menu operation of the one menu operation, updating the menu tree of the intelligent response system based on the content fed back; and uploading the updated menu tree to the server for sharing with other electronic terminals.

In one embodiment, the method further comprises: providing the user with subsequent notes and/or recommended content related to the interaction result with the intelligent response system while or after providing the user with the interaction result.

In one embodiment, the selecting the corresponding candidate item by simulating the user input, according to the user intent and the functions of the candidate items in the interactive menu provided by the intelligent response system further comprises: confirming to the user whether to perform the obtained menu operation path, wherein when a confirmation input of the user is received, the sequentially performing the menu operations in the menu operation path by simulating the user input is executed.

In one embodiment, the providing the user with the interaction result with the intelligent response system comprises: when language used by the interaction result is different from language used by the user input, translating the interaction result in the language used by the user input and providing a translation result to the user.

According to another exemplary embodiment of the present disclosure, an apparatus for interacting with an intelligent response system is provided, wherein the apparatus comprises: an input receiving unit configured to receive a user input; an intent identifying unit configured to identify user intent based on content of the user input; an interacting unit configured to automatically interact with an intelligent response system involved in the user intent to achieve the user intent.

In one embodiment, the apparatus further includes: a result providing unit configured to provide a user with an interaction result with the intelligent response system when the interaction process with the intelligent response system is completed.

In one embodiment, the interacting unit includes: an interaction object determining unit configured to determine the intelligent response system for achieving the user intent; and a selecting unit configured to select a corresponding candidate item by simulating a user input, according to the user intent and functions of candidate items in an interactive menu provided by the intelligent response system.

In one embodiment, the selecting unit includes: a menu tree obtaining unit configured to obtain a menu tree of the intelligent response system, wherein the menu tree is used to indicate candidate items included in an interaction menu at each level of the intelligent response system and functions corresponding to the candidate items; an operation path obtaining unit configured to obtain a menu operation path for achieving the user intent for the menu tree; and a simulating unit configured to sequentially perform menu operations in the menu operation path by simulating a user input, wherein when content fed back by the intelligent response system in response to one menu operation satisfies a trigger condition of a next menu operation of the one menu operation, the simulating unit performs the next menu operation.

In one embodiment, the selecting unit selects a candidate item for achieving the user intent by simulating a user input, based on functions of candidate items in an interaction menu provided in real time by the intelligent response system.

In one embodiment, the interacting unit obtains information for achieving the user intent; and automatically interacts with the intelligent response system involved in the user intent based on the obtained information.

In one embodiment, the interacting unit extracts the information for achieving the user intent from the content of the user input; and/or, the interacting unit obtains context information for achieving the user intent, wherein the context information includes at least one of current environmental information, historical operation information of the electronic terminal, and stored user personalized information.

In one embodiment, the apparatus further includes: a prompting unit configured to prompt the user to supplement corresponding information, wherein when the intent identifying unit cannot identify a user intent, the prompting unit prompts the user to supplement the corresponding information, and the intent identifying unit identifies the user intent based on the information supplemented by the user; and/or, when the interacting unit cannot determine an involved intelligent response system based on the identified user intent, the prompting unit prompts the user to supplement the corresponding information, and the interacting unit determines the involved intelligent response system based on the information supplemented by the user; and/or, when the interacting unit cannot interact with the involved intelligent response system based on the identified user intent, the prompting unit prompts the user to supplement the corresponding information, and the interacting unit interacts with the involved intelligent response system based on the information supplemented by the user.

In one embodiment, the intent identifying unit identifies the user intent based on the content of the user input and context information, wherein the context information comprises at least one of current environment information, historical operation information of the electronic terminal, and stored user personalized information.

In one embodiment, the apparatus further includes: a determining unit configured to confirm to the user whether user privacy information is provided to the intelligent response system when the user privacy information needs to be provided to the intelligent response system, wherein when a confirmation input of the user is received, the interacting unit provides the user privacy information to the intelligent response system during the interaction with the intelligent response system.

In one embodiment, after the interaction process with the intelligent response system ends, when the user intent has not been achieved and the intelligent response system provides other interaction manners for achieving the user intent, the interacting unit automatically interacts in the other interaction manners, wherein the apparatus further includes: a result providing unit configured to provide a corresponding interaction result to the user when the user intent has been achieved in the other interaction manners.

In one embodiment, when the content fed back by the intelligent response system in response to the one menu operation does not satisfy the trigger condition of the next menu operation of the one menu operation, the operation path obtaining unit updates the menu operation path based on the content fed back and the user intent; and the simulating unit sequentially performs menu operations in the updated menu operation path by simulating a user input.

In one embodiment, the apparatus further includes: a menu tree updating unit configured to update the menu tree of the intelligent response system based on the content fed back when the content fed back by the intelligent response system in response to the one menu operation does not satisfy the trigger condition of the next menu operation of the one menu operation; the menu tree managing unit configured to upload the updated menu tree to the server for sharing with other electronic terminals.

In one embodiment, the result providing unit provides subsequent notes and/or recommended content related to the interaction result to the user while or after providing the user with the interaction result with the intelligent response system.

In one embodiment, the selecting unit further includes: an operation path determining unit configured to confirm to the user whether to perform the obtained menu operation path, wherein when receiving a confirmation input of the user, the simulating unit sequentially performs the menu operations in the menu operation path by simulating the user input.

In one embodiment, the result providing unit translates the interaction result in language used by the user input and provides a translation result when language used by the interaction result is different from the language used by the user input.

According to another exemplary embodiment of the present disclosure, an apparatus for interacting with an intelligent response system is provided, wherein the apparatus comprises: a memory configured to store instructions; an input receiving unit configured to receive a user input; and a processor configured to execute the instructions stored in the memory to: identify user intent based on content of the user input; and automatically interact with an intelligent response system involved in the user intent to achieve the user intent.

According to another exemplary embodiment of the present disclosure, a computer readable storage medium storing a computer program is provided, wherein the method for interacting with the intelligent response system as mentioned above is implemented when the computer program is executed by a processor.

According to another exemplary embodiment of the present disclosure, an electronic terminal is provided, wherein the electronic terminal includes: a processor and a memory storing a computer program, wherein the method for interacting with the intelligent response system as mentioned above is implemented when the computer program is executed by the processor.

In the method and apparatus for interacting with the intelligent response system according to an exemplary embodiment of the present disclosure, interacting with the corresponding intelligent response system is automatically performed only based on the user input reflecting the user intent to achieve the user intent without directly interacting with the intelligent response system by the user. Moreover, comparing with the interaction with the intelligent response system by the user himself, it can effectively reduce the time spent on the interaction process, and can effectively avoid the situation of selection errors and misoperations during the interaction process.

Other aspects and/or advantages of the general concept of the present disclosure will be explained in the following descriptions in part, and another part will be clear through the descriptions, or may be learned through implementation of the general concept of the present disclosure.

### MODE FOR THE INVENTION

Embodiments of the present disclosure will be referred to in details now, and examples of the embodiments are illustrated in the accompanying drawings, throughout which the same reference number refers to the same part. The embodiments will be illustrated by referring to the accompanying drawings in the following, so as to explain the present disclosure.

It is to be understood that the singular forms “a,” “an,” and “the” include plural referents unless the context clearly dictates otherwise. Thus, for example, reference to “a component surface” includes reference to one or more of such surfaces.

While describing the embodiments, technical content that is well known in the related fields and not directly related to the disclosure will not be provided. By omitting redundant descriptions, the essence of the disclosure will not be obscured and may be clearly explained.

For the same reasons, components may be exaggerated, omitted, or schematically illustrated in drawings for clarity. Also, the size of each component does not completely reflect the actual size. In the drawings, like reference numerals denote like elements.

As used herein, the term “and/or” includes any and all combinations of one or more of the associated listed items. Expressions such as “at least one of,” when preceding a list of elements, modify the entire list of elements and do not modify the individual elements of the list. Throughout the disclosure, the expression “at least one of a, b or c” indicates only a, only b, only c, both a and b, both a and c, both b and c, all of a, b, and c, or variations thereof.

Advantages and features of one or more embodiments of the disclosure and methods of accomplishing the same may be understood more readily by reference to the following detailed description of the embodiments and the accompanying drawings. In this regard, the present embodiments may have different forms and should not be construed as being limited to the descriptions set forth herein. Rather, these embodiments are provided so that this disclosure will be thorough and complete and will fully convey the concept of the present embodiments to one of ordinary skill in the art, and the disclosure will only be defined by the appended claims.

Here, it will be understood that combinations of blocks in flowcharts or process flow diagrams may be performed by computer program instructions. Since these computer program instructions may be loaded into a processor of a general purpose computer, a special purpose computer, or another programmable data processing apparatus, the instructions, which are performed by a processor of a computer or another programmable data processing apparatus, create units for performing functions described in the flowchart block(s). The computer program instructions may be stored in a computer-usable or computer-readable memory capable of directing a computer or another programmable data processing apparatus to implement a function in a particular manner, and thus the instructions stored in the computer-usable or computer-readable memory may also be capable of producing manufacturing items containing instruction units for performing the functions described in the flowchart block(s). The computer program instructions may also be loaded into a computer or another programmable data processing apparatus, and thus, instructions for operating the computer or the other programmable data processing apparatus by generating a computer-executed process when a series of operations are performed in the computer or the other programmable data processing apparatus may provide operations for performing the functions described in the flowchart block(s).

In addition, each block may represent a portion of a module, segment, or code that includes one or more executable instructions for executing specified logical function(s). It should also be noted that in some alternative implementations, functions mentioned in blocks may occur out of order. For example, two blocks illustrated consecutively may actually be executed substantially concurrently, or the blocks may sometimes be performed in a reverse order according to the corresponding function.

Here, the term “unit” in the embodiments of the disclosure means a software component or hardware component such as a field-programmable gate array (FPGA) or an application-specific integrated circuit (ASIC) and performs a specific function. However, the term “unit” is not limited to software or hardware. The “unit” may be formed so as to be in an addressable storage medium, or may be formed so as to operate one or more processors. Thus, for example, the term “unit” may refer to components such as software components, object-oriented software components, class components, and task components, and may include processes, functions, attributes, procedures, subroutines, segments of program code, drivers, firmware, micro codes, circuits, data, a database, data structures, tables, arrays, or variables. A function provided by the components and “units” may be associated with a smaller number of components and “units”, or may be divided into additional components and “units”. Furthermore, the components and “units” may be embodied to reproduce one or more central processing units (CPUs) in a device or security multimedia card. Also, in the embodiments, the “unit” may include at least one processor. In the disclosure, a controller may also be referred to as a processor.

The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: a, b, and c” includes any of the following combinations: a, b, c, a and b, a and c, b and c, and a and b and c.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Artificial intelligence-related functions according to the disclosure are operated through a processor and a memory. A processor may include one or a plurality of processors. In this case, the one or the plurality of processors may each be a general purpose processor, such as a CPU, an AP, and a digital signal processor (DSP), a graphics dedicated processor, such as a GPU and a vision processing unit (VPU), or an artificial intelligence dedicated processor, such as an NPU. The one or the plurality of processors control to process input data according to a predefined operation rule or an AI model stored in a memory. Alternatively, when the one or the plurality of processors are artificial intelligence dedicated processors, the artificial intelligence dedicated processors may be designed to have a hardware structure specialized for processing a specific AI model.

The predefined operation rule or the AI model may be constructed through learning. Here, construction through learning means that, as a basic AI model is trained by using a plurality of pieces of learning data according to a learning algorithm, a predefined operation rule or an AI model that is set to perform a desired characteristic (or purpose) is constructed. Such learning may be performed in a device in which an AI according to the disclosure is executed or may be performed through a separate server and/or a system. Examples of learning algorithms include supervised learning, unsupervised learning, semi-supervised learning, or reinforcement learning, but are not limited to the above examples.

An AI model may include a plurality of neural network layers. Each of the plurality of neural network layers has a plurality of weight values, and a neural network operation is performed through operations between an operation result of the previous layer and the plurality of weight values. The weight values of the neural network layers may be optimized through learning results of the AI model. For example, the plurality of weight values may be renewed such that a loss value or a cost value obtained by an AI model is during a learning process is reduced or minimized. Artificial neural networks may include a deep neural network (DNN) and may include, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), and a deep Qnetworks, but are not limited to the above examples.

Definitions for other certain words and phrases are provided throughout this patent document. Those of ordinary skill in the art should understand that in many if not most instances, such definitions apply to prior as well as future uses of such defined words and phrases.

Hereinafter, the disclosure will be described in detail with reference to the accompanying drawings.

Embodiment 1

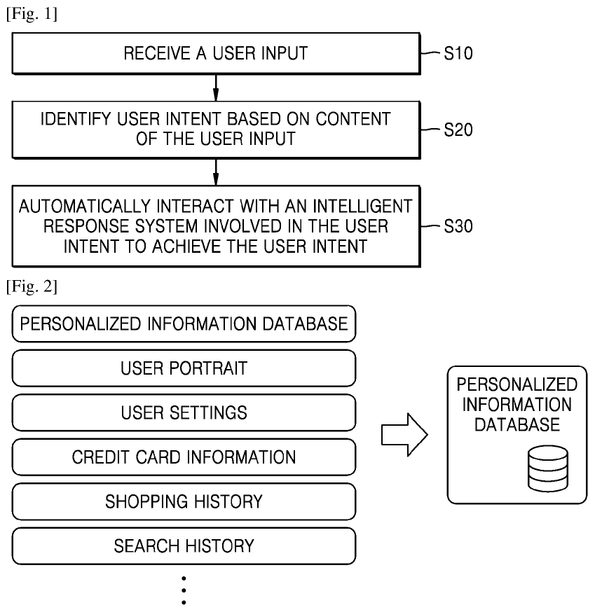

FIG. 1 illustrates a flow chart of a method for interacting with an intelligent response system in accordance with an exemplary embodiment of the present disclosure. The method may be performed by an electronic terminal or by a computer program. For example, the method may be performed by an application installed in the electronic terminal or by a function program implemented in an operating system of the electronic terminal.

Referring to FIG. 1, at operation S10, a user input is received.

As an example, the user input may be a user input for requesting to satisfy a certain demand, and the demand can be satisfied by interacting with an intelligent response system. For example, the user input may be a user input for requesting “querying a telephone charge”, “handling a mobile communication package”, “modifying a single payment limit of a credit card”, “querying this month's consumption bill”, “booking a restaurant”, “booking a hotel”, etc.

As an example, the intelligent response system may be an intelligent response customer service, an automatic response robot, and the like provided by a service provider (e.g., a merchant, a manufacturer, etc.). For example, the intelligent response system may be an intelligent voice call customer service, a public number that can automatically respond, and the like.

As an example, the user input may be a user input in various forms, such as a voice input, a gesture input, a touch input, a key input, and the like.

At operation S20, the user intent is identified based on the content of the user input.

In other words, the demand that the user requests to be satisfied through the user input may be identified by parsing the content of the user input.

At operation S30, interacting with the intelligent response system involved in the user intent is automatically performed to achieve the user intent. In other words, when the user wants to achieve a certain purpose, and the purpose can be achieved by interacting with the intelligent response system, the user only needs to input a user input capable of reflecting the purpose, and in the exemplary embodiment according to the present disclosure, the content of the user input can be automatically parsed to identify the purpose, and the purpose is achieved by automatically performing interacting with the intelligent response system, thereby meeting the user's need.

As an example, a connection with the intelligent response system involved in the user intent may be automatically established and interacting is performing to achieve the user intent. For example, a connection with the intelligent response system may be established by dialing a phone number corresponding to the intelligent response system; or a connection with the intelligent response system is established by opening an interacting interface corresponding to the intelligent response system.

For example, if the user wants to query the telephone charge, the user can input a voice command “querying the telephone charge”, and when receiving the voice command, a connection with the mobile operator's intelligent response system may be automatically established and interacting with the mobile operator's intelligent response system is automatically performed, and an interaction result “a list of the telephone charge” is fed back to the user to meet the need of the user.

As a preferred manner, operation S10, operation S20, and operation S30 may be implemented with reference to the following exemplary embodiments.

Embodiment 2

Operation S20 is described in detail below. At operation S20, the user intent is identified based on the content of the user input.

As an example, the user intent may be identified based on the content of the user input and context information.

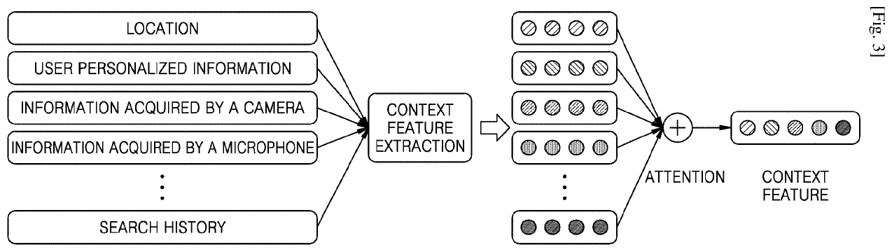

As an example, the context information may include, but is not limited to, at least one of current environmental information, historical operational information of the electronic terminal, or stored user personalized information. For example, the current environmental information may include, but is not limited to, at least one of current location information of the electronic terminal, information collected by a camera, and information collected by a microphone. The stored user personalized information may include, but is not limited to, at least one of user personal information (e.g., credential information, etc.), user portrait, user settings (e.g., a mobile call package currently used by the user), user's consumption history, shopping history, search history, and credit card information. For example, the stored user personalized information may include, but is not limited to, at least one of locally stored user personalized information, and user personalized information stored at server-side. For example, as shown in FIG. 2, the user personalized information may be read from a personalized information database of the electronic terminal. For example, the historical operation information of the electronic terminal may include information related to an operation performed by the electronic terminal within a recent preset time length. For example, the historical operation information of the electronic terminal may include, but is not limited to, at least one of search history of the electronic terminal, content of an interface currently displayed by the electronic terminal, and a browsing history of the electronic terminal.

As an example, a suitable feature extractor may be used to extract features for each type of context information in the obtained context information, respectively. For example, a suitable feature extractor may be used to extract features for the information acquired by the camera in the acquired context information. For example, a Convolutional Neural Network (CNN) may be used to extract features of image type context information, and a Recurrent Neural Network (RNN) may be used to extract features of text type context information.

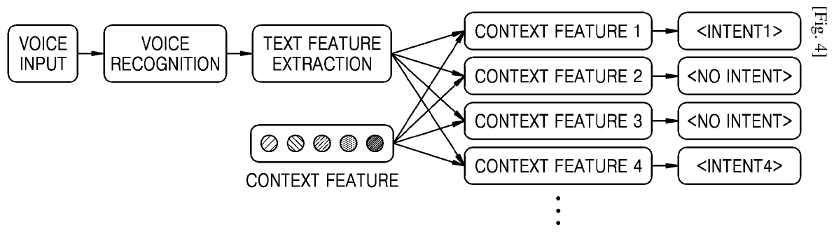

As an example, all features extracted for the context information may be merged to form a context feature, and the user intent is identified based on the content of the user input and the extracted context feature. For example, as shown in FIG. 3, all the features extracted for the context information may be merged to form a context feature by using an attention mechanism, for example, the attention mechanism may be implemented by:

$${F}_{c} = {\sum }_{i = 1}^{n} {α}_{i} {F}_{i} \\ {α}_{i} = F \cdot {F}_{i} ( i = 1 , 2 , … , n )$$

Wherein F represents the features extracted based on the content of the user input; Fᵢ represents a extracted feature of the i-th type context information, for example, a location feature, a camera content feature, etc; F_{c} represents the obtained context feature after merging; αᵢ represents a weight corresponding to each feature when the features are merged.

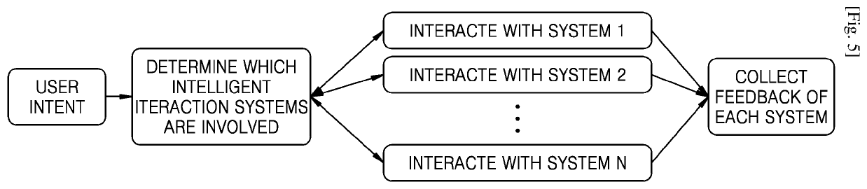

It should be understood that various suitable ways may be used to identify user intent based on the content of the user input. As an example, the user intent may be identified based on the content of the user input through a binary classification approach. As shown in FIG. 4, the user voice input may be recognized as a text by voice recognition, and feature extraction is performed on the recognized text to obtain the feature of the content of the user input, and the obtained feature of the content of the user input and the context feature are input into binary classifiers corresponding to the respective intent. Each of the binary classifiers will output a Boolean value indicating whether the content of the user input includes the corresponding intent, thereby determining the intent that the user wants to express through the user input. For example, if the user's home TV has failed, and the user wants to contact the TV manufacturer's intelligent customer service to check the TV's warranty situation, the user may input a voice command: “My TV has failed, and does it still have a warranty?”. Based on the content of the user's voice input, the user intent may be determined to include: 1. querying the type of fault of the TV and the cause of the fault; 2. querying whether the fault type and the cause of the fault meet the warranty policy. That is, a plurality of user intents may be identified based on the content of the user input.

As an example, the user intent may be identified based on the content of the user input and context information related to the content of the user input.

As an example, context information may be obtained when it is not possible to identify user intent, and then the user intent is identified based on the content of the user input and the context information.

As another example, when the user input is received, the context information is directly acquired, and then the user intent is identified based on the content of the user input and the context information to improve the recognition accuracy of the user intent.

As an example, the user may be prompted to supplement corresponding information when it is not possible to identify user intent; and the user intent is identified based on the information supplemented by the user and the content of the user input. Further, the type of the information that the user needs to supplement may also be specifically prompted.

Embodiment 3

Operation S30 is described in detail below. At operation S30, interacting with the intelligent response system involved in the user intent is automatically performed to achieve the user intent.

As an example, the intelligent response systems involved in the user intent may include one or more intelligent response systems for achieving the user intent, and the intelligent response system for achieving the user intent is an intelligent response system capable of processing the business involved in the user intent. For example, the intelligent response system for achieving the user intent may include an intelligent response system capable of fully achieving the user intent, or an intelligent response system capable of assisting in achieving the user intent. For example, when the user intent is “querying a telephone charge”, the intelligent response system involved in the user intent may be an intelligent response customer service of the network operator currently used by the electronic terminal.

In some cases, in order to achieve the user intent, it may be necessary to interact with a plurality of intelligent response systems. For example, as shown in FIG. 5, interacting with a plurality of intelligent response systems involved in the user intent may be performed to achieve user intent. For example, when the user's voice command “setting the credit card single payment limit to $500” is received, all credit cards of the user may be queried. If it is queried that the user has credit cards of a plurality of banks, it needs to interact with a plurality of intelligent response systems of involved card-opening banks to set a single payment limit for each credit card. It should be understood that interaction with different intelligent response systems may be performed in parallel.

As an example, when it is not possible to determine an involved intelligent response system based on the identified user intent, the user may be prompted to supplement corresponding information and the involved intelligent response system may be determined based on the information supplemented by the user. Further, the type of the information that the user needs to supplement may be specifically prompted. There may be a case where the content of the user input cannot clearly express the user intent, that is, a clear user intent cannot be recognized based on the content of the user input, in this case, the clear user intent may be determined by continuing to interact with the user. For example, when it is recognized that the user intent is “inquiring a credit card bill” based on the content of the user input, if it is detected that the user has a plurality of credit cards belonging to different banks, the user may be asked at “check a bill of which credit card of yours”. And based on a credit card identification information supplemented by the user, it may be determined that the intelligent response system involved in the user intent is an intelligent response system of the bank to which the credit card corresponding to the credit card identification information belongs.

As an example, information for achieving the user intent may be acquired; and based on the acquired information, interacting with the intelligent response system involved in the user intent is automatically performed. Here, the information for achieving the user intent may include auxiliary information required to achieve the user intent.

As an example, the information for achieving the user intent may be extracted from the content of the user input; and/or context information for achieving the user intent may be acquired, wherein the context information includes but is not limited to at least one of current environmental information, historical operation information of the electronic terminal, and stored user personalized information. For example, when the user intent is “reducing the mobile communication package by one level”, the information for achieving the user intent may include information of the currently used mobile communication package, and the like. It should be understood that the information for achieving the user intent may also be acquired in other suitable manners.

As an example, an intelligent response system for achieving the user intent may be determined firstly; then, according to the user intent and the functions of the candidate items in the interactive menu provided by the intelligent response system, the corresponding candidate item is selected by simulating a user input.

As an example, the corresponding candidate item may be selected by simulating a user input such as a touch input, a key input, a voice input, a gesture input, and the like.

As an example, before starting to interact with the intelligent response system, the interaction menu that the intelligent response system will provide may be acquired in advance, and a specific interaction process (e.g., a menu operation path) conforming to the user intent may be pre-planned based on the interaction menu, and then interaction with the intelligent response system is performed in accordance with the pre-planned interaction process by simulating a user input.

As another example, a candidate item for achieving the user intent may be selected according to functions of candidate items in an interactive menu currently provided by the intelligent response system during interaction with the intelligent response system in real time. Specifically, as an example, the candidate item for achieving the user intent may be selected by simulating a user input based on the functions of the candidate items in the interactive menu provided by the intelligent response system in real time. For example, the functions of the candidate items may be analyzed according to the description of the candidates included in the currently provided interactive menu made by the intelligent response system in real time. The candidate items included in the interactive menu at each level of the intelligent response system and the functions corresponding to the candidate items may be obtained in advance to acquire the functions of the candidate items in the interactive menu provided in real time.

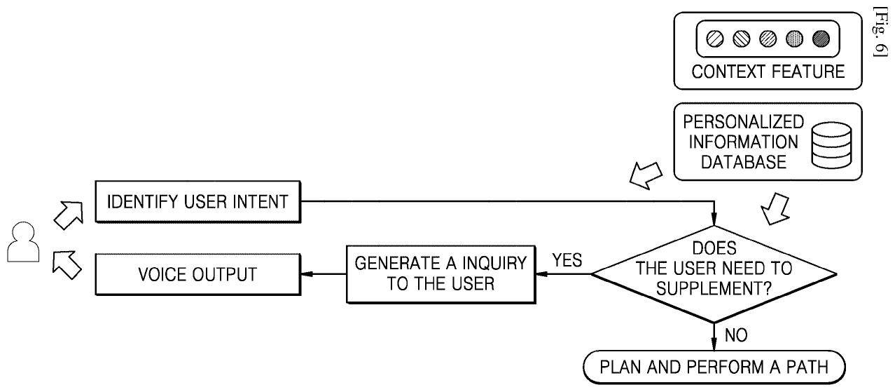

As an example, when it is not possible to interact with the involved intelligent response system based on the identified user intent, the user may be prompted to supplement corresponding information and interaction with the involved intelligent response system is performed based on the information supplemented by the user. Further, the type of the information that the user needs to supplement may be specifically prompted. For example, when it is recognized that the user intent is “lowering the current mobile communication package” based on the content of the user input, if a plurality of mobile communication packages lower than the current mobile communication package are detected, and the user intent is not clearly defined which package the user want to degrade the current package to, the user may be prompted to supplement which package the user want to degrade the current package to. For example, in the interaction process with the intelligent response system, when it is necessary to select a mobile communication package to which the current communication package is to be specifically degraded, the user may be asked which level of mobile communication package the current mobile communication package is specifically degraded to, and interacting with the intelligent response system based on the content supplemented by the user is continued; or, when generating the menu operation path, the user may be asked which level of mobile communication package the current mobile communication package is specifically degraded to, and a menu operation path is generated based on the content supplemented by the user. As shown in FIG. 6, when it is still not possible to interact with the intelligent response system to achieve the corresponding user intent based on the content of the user input and the context information (including stored user personalized information), it may be determined that the user is required to supplement content, and an inquiry to the user is generated based on content that needs to be supplemented, and the inquiry is output through voice. When it is possible to normally interact with the intelligent response system to achieve the corresponding user intent, it may be determined that the user is not required to supplement content, and the menu operation path may be directly generated and the interaction with the intelligent response system is performed based on the menu operation path.

Embodiment 4

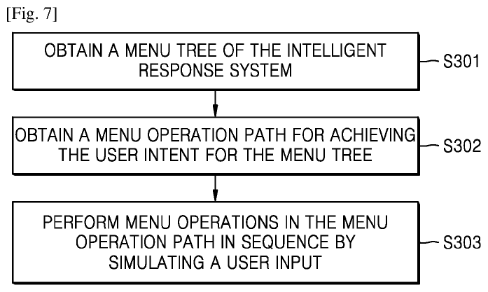

FIG. 7 illustrates a flowchart of a method of selecting a corresponding candidate item by simulating a user input according to the user intent and functions of candidate items in an interactive menu provided by the intelligent response system, according to an exemplary embodiment of the present disclosure.

Referring to FIG. 7, at operation S301, a menu tree of the intelligent response system is acquired.

The intelligent response system provides interaction menus when interacting. Each of interaction menus explicitly or implicitly includes various candidate items, and each of candidate items corresponds to a different function. In the interaction with the intelligent response system, if a certain candidate item is selected, the intelligent response system will perform corresponding operation to achieve the function corresponding to the selected candidate item, for example, jumping to the next level interaction menu corresponding to the selected candidate item, handling corresponding business, outputting corresponding information, and the like. For example, a certain interaction menu may explicitly include a plurality of digital candidate items, each of digital candidate items corresponds to a different function, for example, a number “1” may be input by a touch input or a voice input to select the candidate item “1”, thereby enabling the intelligent response system to perform its corresponding function. For example, a certain interaction menu may implicitly include a plurality of candidate items, and the content corresponding to a certain candidate may be input through a voice input to select the certain candidate item. For example, a candidate item “reservation meal” may be selected by inputting a voice “make an appointment for dinner today” to jump to the next level interactive menu “ the number of people and time of reservation meal” corresponding to “reservation meal”.

The interaction menus at all levels of the intelligent response system form a tree structure, which may be referred to as a menu tree, accordingly, the menu tree is used to indicate candidate items included in the interaction menu at each level of the intelligent response system and functions corresponding the candidate items, in addition, the menu tree may also be used to indicate information such as the specific location of each candidate item in the corresponding interaction interface. For example, for the network operator's intelligent response system, the interaction menu “query bill” may include a plurality of candidate items, each of the candidate items may correspond to a function such as “query telephone charge” or “query traffic usage” respectively.

As an example, the menu tree corresponding to each intelligent response system may be downloaded from the cloud and stored locally.

At operation S302, a menu operation path for achieving the user intent for the menu tree is acquired. In other words, an execution path conforming to the user intent is retrieved in a known menu tree.

At operation S303, menu operations in the menu operation path are sequentially performed by simulating a user input, wherein when the content fed back by the intelligent response system in response to one menu operation satisfies a trigger condition of a next menu operation of the one menu operation, the next menu operation is performed.

As an example, the content fed back by the intelligent response system in response to the one menu operation may be information of an interaction menu that is entered in response to the one menu operation.

As an example, when the content fed back by the intelligent response system in response to the one menu operation does not satisfy the trigger condition of the next menu operation of the one menu operation, the menu operation path may be updated based on the content fed back and the user intent; and the menu operations in the updated menu operation path are sequentially performed by simulating a user input, that is, interacting with the intelligent response system is performed according to the updated menu operation path.

As an example, when the content fed back by the intelligent response system in response to the one menu operation does not satisfy the trigger condition of the next menu operation of the one menu operation, the menu tree of the intelligent response system may be updated based on the content fed back; and the updated menu tree may be uploaded to the server for sharing with other electronic terminals.

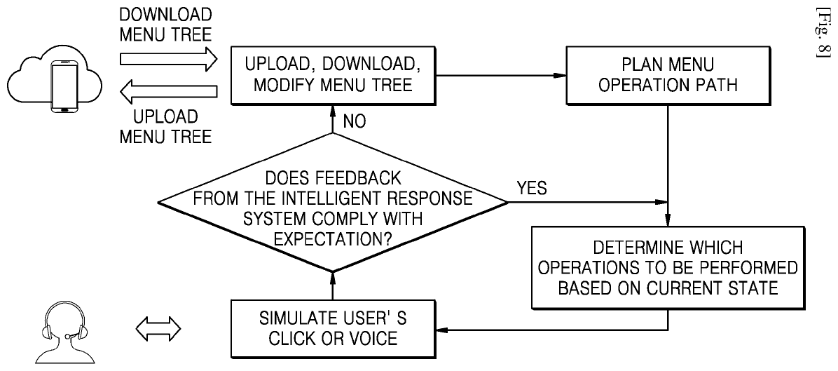

FIG. 8 illustrates an example of interacting with an intelligent response system according to user intent and functions of candidate items in an interactive menu provided by the intelligent response system according to an exemplary embodiment of the present disclosure. Referring to FIG. 8, a menu tree of the intelligent response system may be downloaded from the cloud, and a suitable menu operation path is planned based on the known menu tree according to the user intent. The suitable menu operation path may be a series of click operations or a series of voice commands. For example, if the user intent is “querying telephone charge”, the menu operation path planned according to the menu tree may be first selecting the number 1 (the corresponding function is to jump to the menu for querying the account information), and then selecting the number 3 (the corresponding function is querying the telephone charge); or, inputting “query account information” and then inputting “query the telephone charge” to the intelligent response system. After planning the suitable menu operation path, a user input may be simulated to sequentially perform the menu operations in the menu operation path, and the feedback of the intelligent response system may be obtained. For example, clicking on the number on the screen by the user may be simulated to select a candidate item and a voice of the user may be simulated to input a number and so on. After obtaining the feedback of the intelligent response system, it may be judged whether the feedback is consistent with the expected feedback, if it is consistent, the menu operation path is continued, and if it is inconsistency, the existing menu tree may be modified based on the feedback that is inconsistent with the expectation, and the modified menu tree may be uploaded to the cloud for sharing to other users. The menu operation path may be updated according to the updated menu tree at the electronic terminal, and interaction with the intelligent response system may be performed based on the updated menu operation path.

As an example, it may be confirmed to the user whether to perform the acquired menu operation path, that is, it is confirmed to the user whether interacting with the intelligent response system according to the acquired menu operation path, wherein when the confirmation input of the user is received, operation S303 may be performed.

It may encounter situations where the user intent cannot be directly achieved through simple interaction with the intelligent response system, for example, when the user intent is to lower the mobile call package by one level, since the mobile operator's intelligent response system does not provide candidate item that corresponds to the user intent completely, but in fact, this user intent can be achieved by a combination of several menu operation paths. For example, one menu operation path may be first performed to query the currently used mobile call package; other menu operation path may be performed to query the detailed information of all mobile call packages; then which package is one level lower than the current package is calculated, and another menu operation path may be performed to modify the currently used mobile call package to the calculated one mobile call package. For example, as shown in FIG. 9, the user intent may be acquired based on the content of the user input, and if the menu tree of the corresponding intelligent response system has a candidate item that exactly matches the user intent, the menu operation path corresponding to the user intent may be directly generated based on the menu tree; if the menu tree does not have a candidate item that exactly matches the user intent, a combination of menu operation paths may be generated based on the user intent. For example, by combining a menu operation path for achieving “querying current mobile package”, a menu operation path of “querying all mobile packages” and a menu operation path of “setting package” to achieve user intent of “reducing the mobile call package by one level”. In addition, the generated combination of the menu operation paths may be fed back to the user, and whether or not to perform the combination of the menu operation paths is determined according to the user's permission.

Embodiment 5

As an example, in addition to operation S10, operation S20, and operation S30, the method for interacting with the intelligent response system according to an exemplary embodiment of the present disclosure may further include: conforming to the user whether user privacy information is provided to the intelligent response system when the user privacy information needs to be provided to the intelligent response system, wherein when confirmation input of user is received, the user privacy information is provided to the intelligent response system during interaction with the intelligent response system.

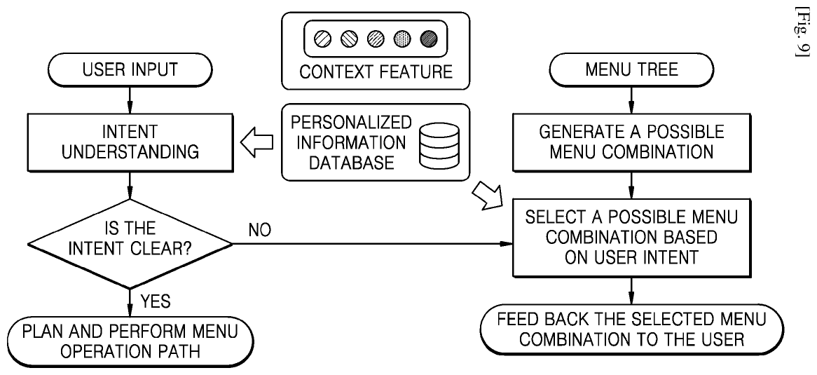

During the interaction with the intelligent response system, the intelligent response system may request input of some information related to the user privacy, such as the user's ID number, account password, etc. Therefore, it may be first determined whether the requested information requires user's confirmation due to relating to user's privacy. When it is determined that user's confirmation is required, the user is requested to perform confirmation, and the above information is provided to the intelligent response system after the user's confirmation. For example, as shown in FIG. 10, during the interaction with the intelligent response system, the intelligent response system may request input of some user personalized information, and when it is detected that the intelligent response system will request or is requesting input of user personalization information during the interaction with the intelligent response system, for example, when it is predicted that the intelligent response system will request user personalized information before starting the interaction (for example, when generating a menu operation path) or the intelligent response system is requesting user personalized information during the interaction, then it is necessary to judge whether the requested user personalized information is privacy information, for example, the privacy information may include, but is not limited to, an account password, numbers of various types of certificates (for example, a social security card number, an ID card number), and the like. If the requested user personalized information is privacy information, the interaction with the user is triggered, and the interaction with the intelligent response system can continue when the user confirms that the requested user personalized information can be provided. If the requested user personalized information is not privacy information, the personalized information database may be directly queried, and if the corresponding user personalized information can be queried in the personalized information database, it may be used in the interaction process with the intelligent response system. If the corresponding content is not queried in the personalized information database, the interaction with the user may be triggered to query the specific content of the user personalized information requested by the intelligent response system.

Embodiment 6

In addition to operation S10, operation S20, and operation S30, the method for interacting with the intelligent response system according to an exemplary embodiment of the present disclosure may further include providing the user with an interaction result with the intelligent response system when the interaction process with the intelligent response system is completed. As an example, the interaction result may include, but is not limited to, at least one of whether the user intent has been successfully achieved, the corresponding content fed back by the intelligent response system when the user intent is successfully achieved, and the reason for the user intent not being successfully achieved.

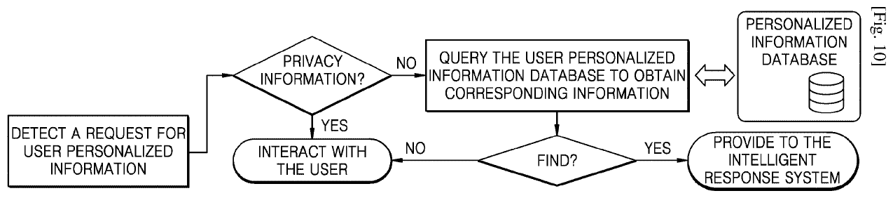

For example, if the user intent is “querying telephone charge”, the content fed back may include: a specific bill of charge that is fed back in the form of a short message or a direct feedback from the intelligent response system. For example, when performing voice interaction with the network operator's intelligent response system to query the mobile communication bill, the intelligent response system may directly feed the specific bill list back in the form of voice, and then feed the specific bill list back again in the form of a short message; or, it is only notified through the voice that the specific bill list will be fed back in the form of a short message and the specific bill list is fed back in the form of a short message. As an example, the received short message may be read and the interaction result in the short message may be obtained to be provided to the user according to the prompt of the intelligent response system. For example, as shown in FIG. 11, during the interaction with the intelligent response system, the content fed back by the intelligent response system may be monitored, if it may be determined that the intelligent response system is to send a short message to the electronic terminal through the history of the interaction with the intelligent response system, the received short message may be read, and it is judged whether the user intent has been achieved (i.e., correctly executed) according to the content of the short message. For example, the user wants to query his own call bill, and if it is recognized that the specific telephone charge list is included in the content of the short message, it may then be determined that the user intent has been achieved. The content of the bill list in the short message may be extracted, the corresponding voice broadcast content may be generated and fed back to the user; and if it is determined that the user intent has not been achieved, the interaction with the intelligent response system may continue.

As an example, subsequent notes and/or recommended content related to the interaction result may also be provided to the user while or after providing the user with the interaction result with the intelligent response system. For example, after the interaction process with the intelligent response system is completed, corresponding feedback may be generated and provided to the user, and the content of the feedback may include: an interaction result with the intelligent response system. In addition, the content of the feedback may also include: subsequent notes, for example, recharging on time to avoid downtime, and the like. In addition, the content of the feedback may further include: recommended content, for example, if the user intent is “modifying the mobile communication package to an unlimited traffic package”, the application APP suitable for the large-traffic package may be recommended to the user.

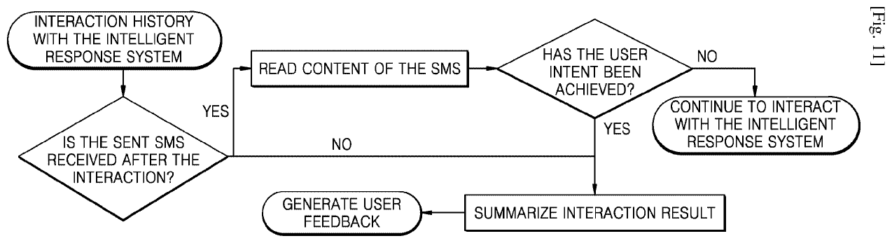

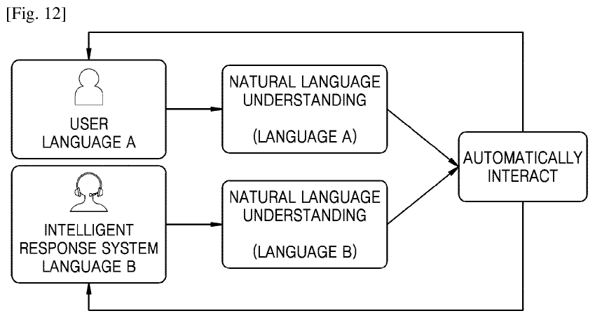

During the interaction process, the language used by the user may be different from the language used by the intelligent response system. As an example, when the language used by the interaction result is different from the language used by the user input, the interaction result may be translated in the language used by the user input and the translation result is provided to the user. For example, when the language used by finally provided the voice interaction result by the intelligent response system is not the language used by the user input, the voice interaction result may be translated in the language used by the user input and the translation result is provided to the user to interact with the user in the user's native language and interact with the intelligent response system using the language provided by the intelligent response system. For example, as shown in FIG. 12, the user uses language A, and the intelligent response system uses language B, according to an exemplary embodiment of the present disclosure, language A may be used to interact with the user through natural language understanding, for example, language A is used when prompting the user to supplement the corresponding information or providing the user with the interaction result with the intelligent response system; and language B is used to interact with the intelligent response system through natural language understanding, for example, language B is used when automatically interacting with the intelligent response system to achieve user intent.

Embodiment 7

In addition to operation S10, operation S20, and operation S30, the method for interacting with the intelligent response system according to an exemplary embodiment of the present disclosure may further include: after the interaction process with the intelligent response system ends, when the user intent has not been achieved and the intelligent response system provides other interaction manners for achieving the user intent, automatically interacting in the other interaction manners; and when the user intent has been achieved in the other interaction manners, providing the user with a corresponding interaction result. For example, the other interaction manners may include, but are not limited to, at least one of interacting with other intelligent response systems and accessing a web address.

In some cases, the user intent has not been fully achieved after completing the interaction process with the intelligent response system, but the intelligent response system may provide other interaction manners for achieving the user intent, for example, the intelligent response system may prompt to continue to achieve the user intent through the other interaction manner (for example, accessing the web address), and send the related information (for example, the specific web address) of the other interaction manner to the electronic terminal in the form of a short message. Correspondingly, the electronic terminal may read the received short message and continue to interact in the other interactive manner according to the information in the short message to achieve the user intent, according to the prompt of the intelligent response system. For example, as shown in FIG. 13, the content of the received short message may be parsed in various appropriate manners to obtain the other interaction manner involved in the content of the short message; and then, it may be determined whether the interaction may be continued in the other interaction manner. When it is determined that the interaction can be continued in the other interaction manner, the interaction may be continued in the other interaction manner, and the interaction result may be provided to the user. When it is determined that the interaction cannot be continued in the other interaction manner, the feedback to the user may be generated and provided to the user. For example, the web address in the short message content may be automatically read and accessed to achieve the user intent, and when the user intent is achieved by accessing the web address, the corresponding interaction result is provided to the user.

Embodiment 8

FIG. 14 illustrates an example of interacting with an intelligent response system according to an exemplary embodiment of the present disclosure. As shown in FIG. 14, a user wants to dial an intelligent response customer service and perform some operations through the customer service, for example, querying the telephone charge, modifying the package content provided by the operator, reserving a restaurant, booking a hotel, modifying the credit card limit, etc. The user may input his own intent into the electronic terminal in the form of natural language (i.e., voice) or text. According to an exemplary embodiment of the present disclosure, the electronic terminal may understand the user intent after receiving the above user's instruction, and the electronic terminal may understand the user intent using the personalization information database and the content of the multi-modal input, and then retrieve the menu operation path that matches the user intent in a predefined menu tree corresponding to the intelligent response customer service, and perform menu operation actions in the menu operation path by simulating a user input (e.g., simulating the user's click action, simulating the user's voice, etc.). Specifically, the user input may be simulated to dial the intelligent response customer service and interact with the intelligent response customer service, and the content fed back by the intelligent response customer service may also be understood through the same process as understanding the user intent, when the understood content fed back by the customer service satisfies the trigger condition of the next menu operation, the next menu operation is performed, until the user intent is satisfied. Here, the content of the multi-modal input may include the content input by the user such as the content supplemented by the user after prompting the user to supplement the corresponding content and the like, and may also include related content provided by the intelligent response customer service, for example, text information and/or picture information and the like in a message such as a short message sent by the intelligent response customer service.

The method for interacting with an intelligent response system according to an exemplary embodiment of the present disclosure can automatically interact with the corresponding intelligent response system only based on the user input embodying the user intent, and the user intent can be achieved without the user directly interacting with the intelligent response system. Moreover, comparing with the interaction with the intelligent response system by the user himself, it can effectively reduce the time spent on the interaction process, and can effectively avoid selection errors and misoperations during the interaction process. At least the following problems existing in the prior art can be solved:

(1) The user usually needs to listen to the complete voice broadcast content before deciding how to choose between the candidate items, and this process consumes the user's time and energy;

(2) The user does not know the submenu that may follow each candidate, in order to provide more content to the user, the intelligent response system often designs a very deep menu tree, and it is difficult for the user to select an option suitable for himself according to the description of the menu;

(3) The cost of trial and error and misoperation of the user is very high, once the user chooses wrongly or operates wrongly during the interaction process, he needs to reselect from the beginning;

(4) The user needs to find a candidate item that suits himself in a deep menu tree, and the candidate item cannot be automatically selected according to the user intent;

(5) The intelligent response system may only provide one language, and if the user is not familiar with the language, it may cause communication difficulties.

Embodiment 9

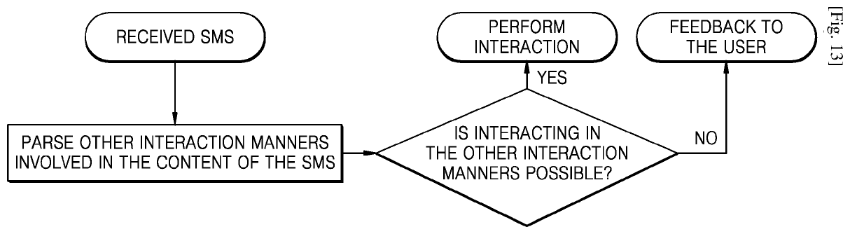

FIG. 15 illustrates a structural block diagram of an apparatus for interacting with an intelligent response system according to an exemplary embodiment of the present disclosure.

As shown in FIG. 15, an apparatus for interacting with an intelligent response system according to an exemplary embodiment of the present disclosure includes an input receiving unit 10, an intent identifying unit 20, and an interacting unit 30.

In particular, the input receiving unit 10 is configured to receive a user input.

The intent identifying unit 20 is configured to identify user intent based on content of the user input.

As an example, the intent identifying unit 20 may identify the user intent based on the content of the user input and context information. As an example, the context information may include at least one of current environmental information, historical operational information of the electronic terminal, and stored user personalized information.

The interacting unit 30 is configured to automatically interact with an intelligent response system involved in the user intent to achieve the user intent.

As an example, the interacting unit 30 may obtain information for achieving the user intent, and based on the obtained information, automatically interact with the intelligent response system involved in the user intent.

As an example, the interacting unit 30 may extract information for achieving the user intent from the content of the user input.

As another example, the interacting unit 30 may obtain context information for achieving the user intent.

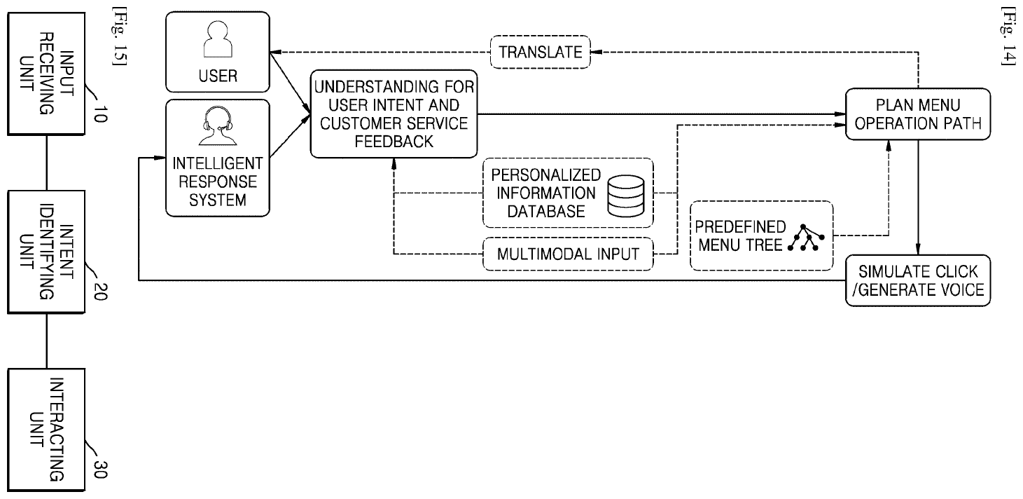

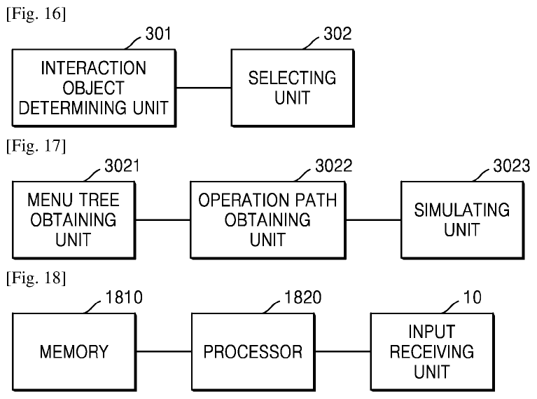

FIG. 16 illustrates a structural block diagram of the interacting unit 30 according to an exemplary embodiment of the present disclosure.

As shown in FIG. 16, the interacting unit 30 according to an exemplary embodiment of the present disclosure includes an interaction object determining unit 301 and a selecting unit 302.

Specifically, the interaction object determining unit 301 is configured to determine the intelligent response system for achieving the user intent.

The selecting unit 302 is configured to select a corresponding candidate item by simulating a user input according to the user intent and functions of candidate items in an interactive menu provided by the intelligent response system.

As an example, the selecting unit 302 may select a candidate item for achieving the user intent by simulating a user input based on functions of candidate items in an interactive menu provided by the intelligent response system in real time.

FIG. 17 illustrates a structural block diagram of the selecting unit 302 according to another exemplary embodiment of the present disclosure.

As shown in FIG. 17, the selecting unit 302 according to another exemplary embodiment of the present disclosure includes a menu tree obtaining unit 3021, an operation path obtaining unit 3022, and a simulating unit 3023.

Specifically, the menu tree obtaining unit 3021 is configured to obtain a menu tree of the intelligent response system, where the menu tree is used to indicate candidate items included in an interaction menu at each level of the intelligent response system and functions corresponding to the candidate items.

The operation path obtaining unit 3022 is configured to obtain a menu operation path for achieving the user intent for the menu tree.

The simulating unit 3023 is configured to sequentially perform a menu operation in the menu operation path by simulating a user input, wherein when content fed back by the intelligent response system in response to one menu operation satisfies a trigger condition of next menu operation of the one menu operation, the simulating unit 3023 performs the next menu operation.

As an example, when the content fed back by the intelligent response system in response to the one menu operation does not satisfy the trigger condition of the next menu operation of the one menu operation, the operation path obtaining unit 3022 may update the menu operation path based on the content fed back and the user intent; and, the simulating unit 3023 may sequentially perform menu operations in the updated menu operation path by simulating a user input.

As an example, the selecting unit 302 according to another exemplary embodiment of the present disclosure may further include an operation path determining unit (not shown). The operation path determining unit is configured to confirm to the user whether to perform the obtained menu operation path, wherein, upon receiving a confirmation input of the user, the simulating unit 3023 sequentially performs the menu operations in the menu operation path by simulating a user input.

As an example, an apparatus for interacting with an intelligent response system according to an exemplary embodiment of the present disclosure may further include: a menu tree updating unit (not shown) and a menu tree managing unit (not shown). The menu tree updating unit is configured to update a menu tree of the intelligent response system based on the content fed back by the intelligent response system in response to the one menu operation when the content fed back does not satisfy the trigger condition of the next menu operation of the one menu operation. The menu tree managing unit is configured to upload the updated menu tree to the server for sharing with other electronic terminals.

As an example, an apparatus for interacting with an intelligent response system according to an exemplary embodiment of the present disclosure may further include a prompting unit (not shown) configured to prompt the user to supplement corresponding information.

As an example, when the intent identifying unit 20 cannot identify the user intent, the prompting unit may prompt the user to supplement corresponding information, and the intent identifying unit 20 may identify the user intent based on the information supplemented by the user.

As another example, when the interacting unit 30 cannot determine the involved intelligent response system based on the identified user intent, the prompting unit may prompt the user to supplement corresponding information, and the interacting unit 30 may determine the involved intelligent response system based on the information supplemented by the user.

As another example, when the interacting unit 30 cannot interact with the involved intelligent response system based on the identified user intent, the prompting unit may prompt the user to supplement corresponding information, and the interacting unit 30 may interact with the involved intelligent response system based on the information supplemented by the user.

As an example, an apparatus for interacting with an intelligent response system according to an exemplary embodiment of the present disclosure may further include a determining unit (not shown). The determining unit is configured to confirm to the user whether user privacy information is provided to the intelligent response system when the user privacy information needs to be provided to the intelligent response system, wherein when a confirmation input of the user is received, the interaction unit 30 provides the user privacy information to the intelligent response system during interaction with the intelligent response system.

As an example, an apparatus for interacting with an intelligent response system according to an exemplary embodiment of the present disclosure may further include a result providing unit (not shown), the result providing unit is configured to provide an interaction result with the intelligent response system to the user when the interaction process with the intelligent response system is completed.

As an example, the result providing unit may also translate the interaction result in language used by the user input and provide a translation result to the user when language used by the interaction result is different from the language used by the user input.

As an example, the result providing unit may also provide subsequent notes and/or recommended content related to the interaction result to the user while or after providing the user with the interaction result with the intelligent response system.

As an example, after the interaction process with the intelligent response system ends, when the user intent has not been achieved and the intelligent response system provides other interaction manners for achieving the user intent, the interacting unit 30 may automatically interact in the other interaction manners. As an example, further, the result providing unit may further provide a corresponding interaction result to the user when the user intent is achieved in the other interaction manner.

FIG. 18 illustrates a structural block diagram of an apparatus for interacting with an intelligent response system according to an exemplary embodiment of the present disclosure.

As shown in FIG. 18, an apparatus for interacting with an intelligent response system according to an exemplary embodiment of the present disclosure includes a memory 1810, an input receiving unit 10, and a processor 1820. The processor 1820 may be configured to execute the instructions stored in the memory to identify user intent based on content of the user input, and automatically interact with an intelligent response system involved in the user intent to achieve the user intent.

It should be understood that the apparatus for interacting with the intelligent response system according to an exemplary embodiment of the present disclosure may perform the method for interacting with the intelligent response system described with reference to FIGS. 1-14, and in order to avoid redundancy, no further details are repeated herein.

It should be understood that each of the units in the apparatus for interacting with an intelligent response system in accordance with an exemplary embodiment of the present disclosure may be implemented as a hardware component and/or a software component. Those skilled in the art can implement each of the units, for example, using a Field Programmable Gate Array (FPGA) or an Application Specific Integrated Circuit (ASIC), according to defined processing performed by each of the units.

An exemplary embodiment of the present disclosure provides a computer readable storage medium storing a computer program, wherein the method for interacting with the intelligent response system as described in the above exemplary embodiments is implemented when the computer program is executed by a processor. The computer readable storage medium is any data storage device that can store data that is read by a computer system. Examples of computer readable storage medium include read only memory, random access memory, read-only optical disk, magnetic tapes, floppy disk, optical data storage device, and carrier waves (such as data transmission over the Internet via a wired or wireless transmission path).

An electronic terminal according to an exemplary embodiment of the present disclosure includes a processor 1820 and a memory 1810, wherein the memory storing a computer program, wherein the method for interacting with the intelligent response system as described in the above exemplary embodiments is implemented when the computer program is executed by the processor.

Although some exemplary embodiments of the present disclosure are expressed and described, those skilled in the art should understand that, modification may be made to these embodiments without departing from the principle and spirit of the present disclosure of which the scope is defined by the claims and the equivalents thereof.

1. A method for interacting with an intelligent response system, wherein the method comprises comprising:
receiving a user input;
identifying user intent based on content of the user input; and
automatically interacting with an-the intelligent response system involved in the user intent to achieve the user intent.

2. The method of claim 1, wherein the received user input includes a user voice input.

3. The method of claim 1, wherein the automatic interacting with the intelligent response system comprises:
simulating a user input according to the user intent, wherein the simulated user input includes a simulated user voice input or a simulated user touch input.

4. The method of claim 1, wherein the automatic interacting with the intelligent response system comprises:
determining a plurality of intelligent response systems for achieving the user intent; and
automatically interacting with the plurality of intelligent response systems.

5. The method of claim 1, wherein the automatic interacting with the intelligent response system involved in the user intent comprises:
selecting a corresponding candidate item by simulating a user input according to the user intent and functions of candidate items in an interactive menu provided by the intelligent response system.

6. The method of claim 5, wherein the selecting of the corresponding candidate item comprises:
obtaining a menu tree of the intelligent response system, wherein the menu tree is used to indicate candidate items included in an interactive menu at each level of the intelligent response system and functions corresponding to the candidate items;
obtaining a menu operation path for achieving the user intent for the menu tree; and
performing menu operations in the menu operation path in sequence by simulating a user input,
wherein when content fed back by the intelligent response system in response to one menu operation satisfies a trigger condition for a next menu operation of the one menu operation, the next menu operation is performed.

7. The method of claim 1, further comprising at least one of:
prompting a user to supplement corresponding information and identifying the user intent based on the information supplemented by the user, when the user intent cannot be recognized; or
prompting the user to supplement corresponding information and determining the involved intelligent response system based on the information supplemented by the user, when the involved intelligent response system cannot be determined based on the identified user intent.

8. The method of claim 1 wherein the identifying of the user intent based on the content of the user input comprises:
identifying the user intent based on the content of the user input and context information,
wherein the context information includes at least one of current environment information, historical operation information of an electronic terminal, or stored user personalized information.

9. The method of claim 1, further comprising:
confirming to a user whether user privacy information is provided to the intelligent response system, when the user privacy information needs to be provided to the intelligent response system,
wherein the user privacy information is provided to the intelligent response system during the interaction with the intelligent response system when a confirmation input of the user is received.

10. The method of claim 1, further comprising:
when the user intent has not been achieved and the intelligent response system provides other interaction manners for achieving the user intent, automatically interacting in the other interaction manners.

11. The method of claim 6, wherein the selecting of the corresponding candidate item comprises:
when the content fed back by the intelligent response system in response to the one menu operation does not satisfy the trigger condition for the next menu operation of the one menu operation, updating the menu operation path based on the content fed back and the user intent; and
performing menu operations in the updated menu operation path in sequence by simulating a user input.

12. The method of claim 11, further comprising:
when the content fed back by the intelligent response system in response to the one menu operation does not satisfy the trigger condition for the next menu operation of the one menu operation, updating the menu tree of the intelligent response system based on the content fed back; and
uploading the updated menu tree to a server for sharing with other electronic terminals.

13. The method of claim 1, further comprising:
providing a user with an interaction result with the intelligent response system, when the interaction with the intelligent response system is completed; and
when language used by the interaction result is different from language used by the user input, translating the interaction result in the language used by the user input and providing a translation result to the user.

14. An apparatus for interacting with an intelligent response system, the apparatus comprising:
a memory configured to store instructions;
an input receiving unit configured to receive a user input; and
a processor configured to execute the instructions stored in the memory to:
identify user intent based on content of the user input, and
automatically interact with the intelligent response system involved in the user intent to achieve the user intent.

15. A non-transitory computer readable storage medium storing instructions, which when executed by a processor, cause the processor to:
receive a user input;
identifying user intent based on content of the user input and
automatically interact with an intelligent response system involved in the user intent to achieve the user intent.
